(19) United States
(12) Patent Application Publication
(10) Pub. No.: US 2011/0071939 A1
(43) Pub. Date: Mar. 24, 2011

(54) Electronic loan preparation and loan selection system

(76) Inventors: Senate Langston, Chicago, IL (US); John Hendrik Park, Chicago, IL (US)

(21) Appl. No.: 12/807,874

(22) Filed: Sep. 17, 2010

Related U.S. Application Data
(60) Provisional application No. 61/244,075, filed on Sep. 20, 2009.

(51) Int. Cl. G06Q 40/00

(52) U.S. Cl. 705/38

(57) ABSTRACT

This is a utility patent application for a new method that allows users (borrowers) to obtain mortgage financing.

### CROSS-REFERENCE TO RELATED APPLICATIONS

Utility Patent (Provisional)

Title of Invention—Electronic Loan Preparation and Loan Selection System

Application No. 61/244,075

Filing Date—Sep. 20, 2009

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is in the technical field of software. More particularly, the present invention is in the technical field of electronic commerce. Currently, there exists 3 common ways for borrowers to obtain a mortgage; a mortgage broker, retail lender or an online lender.

Mortgage Brokers

Mortgage brokers are professionals who are paid a fee to bring together lenders and borrowers. They find and evaluate home buyers, analyzing each borrower's credit situation to determine which lender is the best fit for that person's needs. The broker submits the home buyer's application to one or more lenders in order to sell it, and works with the chosen lender until the loan closes.

Mortgage brokers charge fees and/or points; additionally a rebate is paid, Yield Spread Premium, when brokers successfully sell borrowers a loan with an above-average interest rate. The mortgage broker often works with a set of known lenders and may not be knowledgeable of the best potential lenders or loan products available to the borrower. Mortgage brokers can pad genuine fees and invent new ones to increase profits, origination fees for example. When a mortgage broker submits a loan to the lender, there is no guarantee that the loan will be approved often because mortgage brokers chose loan products that are in their best interest and not the borrower's or the mortgage broker fails to obtain all the necessary information for the lender. When working with mortgage brokers, the agreed upon details of the loan can be different at the time of closing, even though the borrowers information remained unchanged. Mortgage brokers usually charge a fee of 1-2 percent of the loan amount.

Borrowers who choose to shop around must engage in a time consuming effort of submitting their information to multiple mortgage brokers while waiting for quotes; quotes that may not be honored when the deal actually closes.

Retail Lenders

Lenders who lend money directly to the public are called Retail Lenders. Banks, credit unions, savings and loans institutions, and mortgage bankers are all examples of retail lenders. Retail lenders employ loan officers to find and evaluate home buyers, analyzing borrower's credit situation to determine if their lender's product offerings meets the person's needs. Unlike the mortgage broker, the retail lender is in control of the whole loan process. Like mortgage brokers, retail lenders charge fees and/or points but generally offer higher interest rates in order to cover marketing and operating costs. In addition, retail lenders have access only to their company's product offerings, which limits the borrower's options. Loan officers are usually paid on commission which may lead to offering loan products that do not result in the best deal for the borrower. If a borrower does not qualify for a loan or is unsatisfied with the loan terms, they must start the process over with another retail lender.

Online Lenders

By leveraging technology, online lenders can offer better loan terms as a result of reduced overhead costs. However, as with retail lenders, they only have access to their company's product offerings. To gain access to a larger and more competitive selection of loan products, a borrower must enter preliminary personal and financial information at multiple websites. Borrowers must track and compare offers from those websites. In this scenario, if a borrower chooses a loan product, as is the case with mortgage brokers and retail lenders, the borrower must work with a loan officer to submit actual financial information and documentation to determine if they qualify. Often, the borrower does not qualify for the selected loan product, once the actual financial and documentation has been submitted.

### BRIEF SUMMARY OF THE INVENTION

With the present invention, users compile personal and financial information along with supporting documentation once. The system is responsible for assisting borrowers in gathering information and documentation required by lenders. End users (borrowers) will choose from a competitive selection of loan products in the system supplied by a network of lenders. There are no limits to the number of lenders or loan products in the system. The user's information and supporting documentation is then submitted to the lender(s) for the purpose of obtaining a loan.

### BRIEF DESCRIPTION OF THE SEVERAL VIEWS OF THE DRAWING

FIG. 1 is a representation of the system workflow.

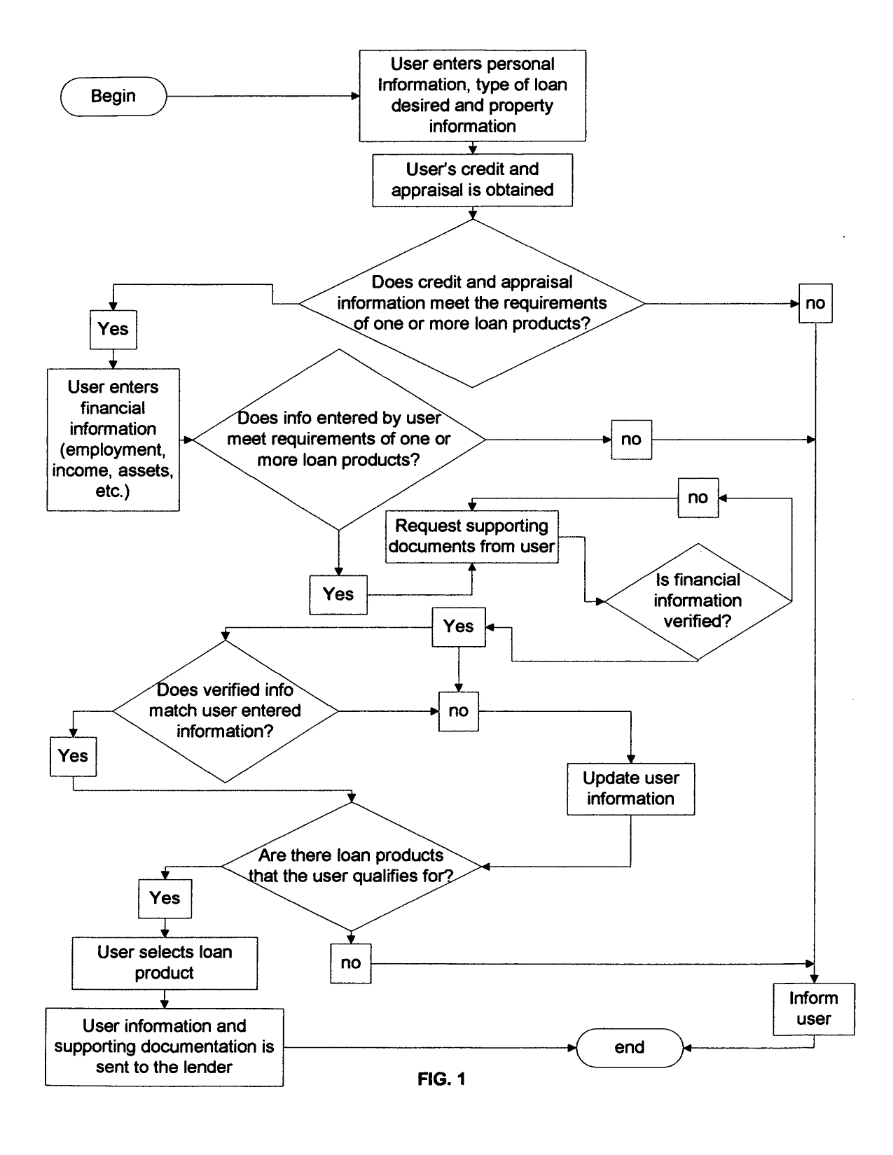

FIG. 2 is a representation of the system architecture overview.

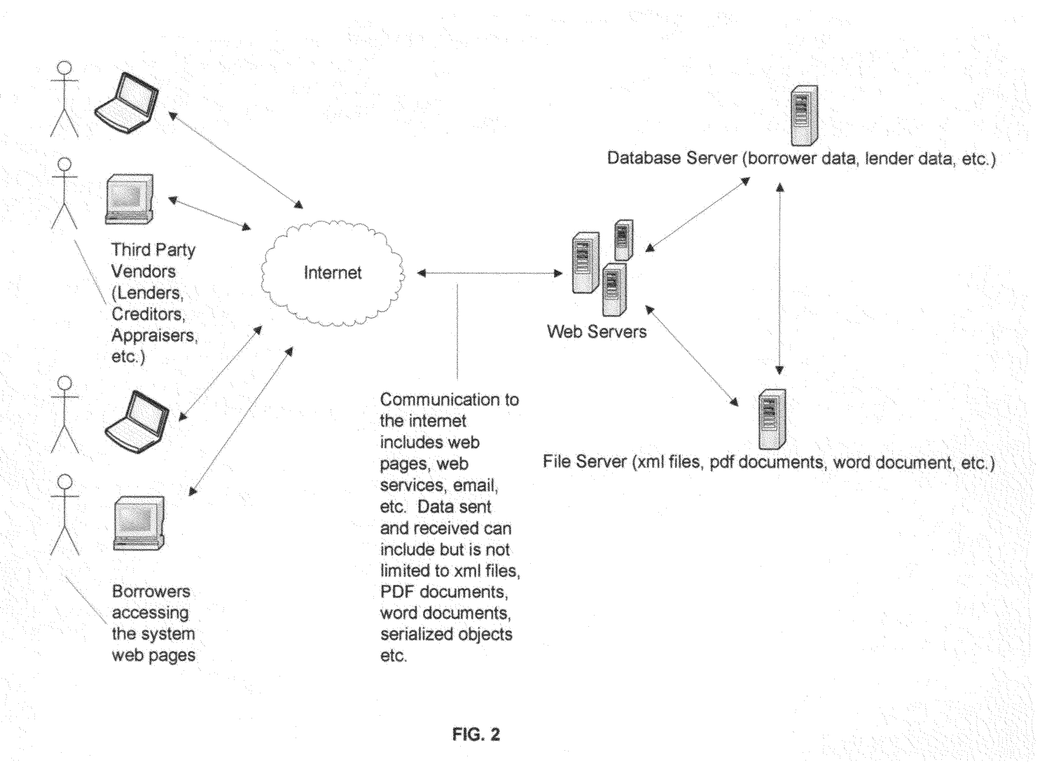

### DETAILED DESCRIPTION OF THE INVENTION

Via the Internet, users will navigate to a URL Users will answer a series of questions online. The questions assist users in providing the required information for obtaining a loan as well as determining what supporting documentation is needed. The system also assists in determining whether or not the user qualifies for one of the available loan products. For example, the user is first prompted to submit only information needed to obtain credit data. If the user's credit is such that it does not meet the requirements of any loan products, the user is informed immediately.

Once the user has completed answering the questions, the system will determine which documents must be submitted by the user. Users can upload, fax, or email documents as well as submit copies via standard mail. Once the user's documentation is received, the user's information is verified and updated if necessary. Subsequently, the user is provided with a list of loan products. This list is comprised of loan products that user qualifies for based on user's verified financial data. The user's information and supporting documentation is sent to the lender indicating which loan product has been selected. The information is submitted to the lender in a manner that meets industry standards. Once the lender has the user's information and supporting documentation, the lender will then proceed with the necessary steps needed to close the loan.

System Architecture Overview

In the description below when referring to:
Data being stored locally—this includes but not is limited to a database and files such as Portable Document Format (PDF), Word format documents, and Tagged Image File Format (TIFF).
Data being accessed externally—this includes but not limited to web services and web pages.
Interact with third parties—this includes but not limited to web services, emails, etc.

The invention is an electronic commerce website. The website has a web interface that users interact with to provide all information and supported documentation required to obtain a loan. User's information and documentation is stored in a datacenter. The information is cross-checked with lender data that is stored datacenter or accessed externally. The lender data contains current qualifying criteria for each loan product offered.

The system will interact with lenders to obtain loan product information and submit required information and documentation needed to secure a loan. In addition, the system will interact with other third party vendors to obtain additional information required by lenders (e.g. credit report, appraisal, etc.).

1. A software system comprised of the ability for users to compile and submit ACTUAL required information and documentation in an effort to obtain mortgage financing without the need of human interaction (e.g. Mortgage Brokers, Loan Processors, Loan Officers, etc.)

2. A software system that allows users to submit required information and documentation directly to lenders in a manner that meets industry standards.

3. A software system that allows users to choose loan products based on ACTUAL verified financial data.

4. A software system that allows users to select from a vast array of loan products. This list extends beyond a single mortgage broker's portfolio or a single lender's portfolio. This list is limited only by number of lenders on the system. Ideally, if all lenders participate in the system, then user will have access to all possible loan products they qualify for.
